(19) United States
(12) Patent Application Publication
(10) Pub. No.: US 2005/0159140 A1
(43) Pub. Date: Jul. 21, 2005

(54) System and method for providing news service

(76) Inventor: Ching-Shyang Hwang, Taipei (TW)

Correspondence Address: BIRCH STEWART KOLASCH & BIRCH, PO BOX 747, FALLS CHURCH, VA, 22040-0747, US

(21) Appl. No.: 10/807,379

(22) Filed: Mar. 24, 2004

(30) Foreign Application Priority Data
Jan. 16, 2004 (TW) 093101285

(51) Int. Cl. H04B 1/16

(52) U.S. Cl. 455/414.1

(57) ABSTRACT

A system for providing news service includes a news-establishing module, a news database, a key-word database, a value-adding module, and an output module. The news-establishing module establishes a plurality of original news data. The news database stores the original news data, and the key-word database stores plural sets of key words. The sets of key words at least include a plurality of classification codes. The value-adding module generates at least one value-added news information according to at least one key word and at least one original news data. The output module outputs the value-added news information. Furthermore, a method for providing news service and a recording medium, having a computer executable program for performing the method, are provided.

### BACKGROUND OF THE INVENTION

1. Field of Invention

The invention relates to a system and a method for providing news service and, in particular, to a system and a method for providing news service, which can provide value-added and personalized news information.

2. Related Art

Accompanying with the knowledge-based economy age, news has become a daily expense product for the individual, company and government. The conventional news service system includes the newspaper service, the TV news program service, and the Internet news service.

The newspaper service delivers daily papers, evening papers, weekly publications, monthly publications, or magazines, which are printed with news, to the clients by manpower or mail. Since the news is published in the daily papers, evening papers, weekly publications, monthly publications, or magazines, the newspaper service requires lots of manpower and is short of efficiency. Furthermore, since the newspaper service provides the publications periodically, the publications cannot present the news immediately. In addition, the publications only present the news to the client, and the client cannot automatically manage his interesting contents or news. The client also cannot analyze his personalized news.

The TV news program service produces the news program and broadcasts it to the clients, and the client's television receives the broadcasted digital or analog signals and presents the news program to the client. However, since the news program is produced and presented on the screen, the client can only watch the news program and catch what the news program presents. The client thus cannot choose his interesting news immediately. Although those skilled persons try to transform the TV programs into electrical files so as to broadcast them on the web, it is difficult to perform the broadcasting of the electrical files smoothly. Thus, the client cannot automatically manage his interesting contents or news and analyze his personalized news.

The Internet news service transmits the news to the clients via Internet, and the client opens the news channel of a computer to receive the news. Since the news is passed through Internet, the Internet news service is very efficient. However, since there is no proper news managing tool, the client cannot efficiently manage his interesting contents or news. The client also cannot analyze his personalized news.

In practice, the above-mentioned news service systems have their own markets and provide the value-added service by their own ways.

The newspaper service system provides the value-added service by newspaper cuttings. In details, the newspaper service system cuts the valued newspaper for later referring. No matter the newspaper cuttings are prepared by the newspaper service system or others, the conventional newspaper cuttings, however, have problems of preservation, searching, and news analyzing. Thus, the client also cannot get his personalized news efficiently.

The TV news program service system provides the value-added service by videotapes or records. For example, the TV news program service system records the valued TV programs for later referring. However, no matter the videotapes are prepared by the TV news program service system or others, it is hard for the client to extract his interesting portions. Thus, the client also cannot get his personalized news efficiently.

The Internet news service system provides the value-added service by electronic papers. For example, the Internet news service system collects the valued news to publish the electronic papers, and then transmits the electronic papers to the clients via Internet. However, the information and news collected in the electronic papers is hard to be searched, and the news published in the electronic papers cannot be analyzed efficiently. Furthermore, the conventional personalized electronic papers contain the news searched from the Internet in different formats, and the client, thus, cannot get his personalized news efficiently.

Therefore, it is an important subjective of the invention to provide a system and a method for providing news service that can provide the value-added and personalized service efficiently.

### SUMMARY OF THE INVENTION

In view of the foregoing subjective, the invention is to provide a system and a method for providing news service, which can provide the value-added service efficiently.

To achieve the above-mentioned, a system for providing news service includes a news-establishing module, a news database, a key-word database, a value-adding module, and an output module. In the invention, the news-establishing module establishes a plurality of original news data. The news database stores the original news data, and the key-word database stores plural sets of key words. The sets of key words at least include a plurality of classification codes. The value-adding module generates at least one value-added news information according to at least one key word and at least one original news data. Finally, the output module outputs the value-added news information.

The invention also provides a method for providing news service, which includes the following steps of: establishing a plurality of original news data; establishing a key-word database, wherein the key-word database stores plural sets of key words and the sets of key words at least comprises a plurality of classification codes; generating at least one value-added news information according to at least one of the key words and at least one of the original news data; and outputting the value-added news information.

The invention further provides a recording medium, which records a computer readable news service program. The news service program is for the computer to perform the above-mentioned method for providing news service of the invention.

As mentioned above, the system and method for providing news service of the invention pre-establishes the key-word database, which stores plural sets of classification codes such as the international classification codes. Therefore, the original news data can be classified and/or tagged according to the key words, so as to generate the preferred value-added news information. Moreover, the system and method of the invention can provide the personalized news service fitting the requirements of the clients.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing a system for providing news service according to a preferred embodiment of the invention;

FIG. 2 is a flow chart showing a method for providing news service according to a preferred embodiment of the invention;

FIG. 3 is a schematic view showing an original news data built by a news-establishing module according to a preferred embodiment of the invention;

FIG. 4 is a schematic view showing a relationship table according to a preferred embodiment of the invention; and

FIG. 5 is a schematic view showing a value-added news information according to a preferred embodiment of the invention.

### DETAILED DESCRIPTION OF THE INVENTION

The system and method for providing news service according to preferred embodiments of the invention will be described herein below with reference to the accompanying drawings, wherein the same reference numbers refer to the same elements.

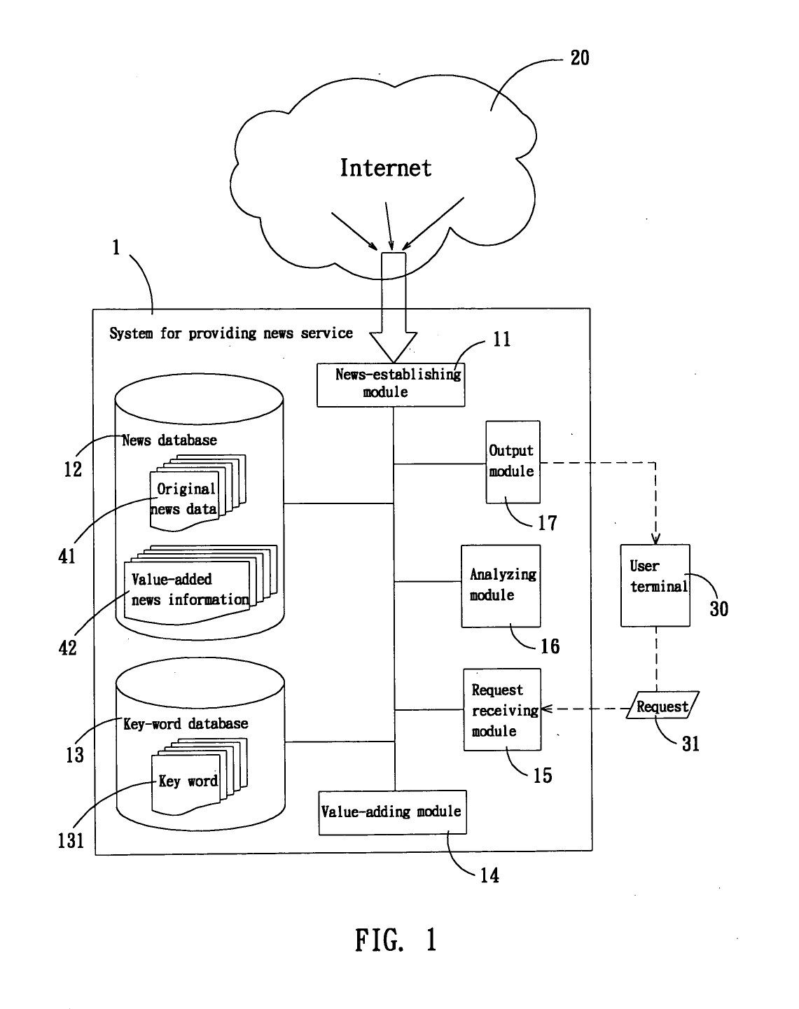

With reference to FIG. 1, a system for providing news service 1 includes a news-establishing module 11, a news database 12, a key-word database 13, a value-adding module 14, a request receiving module 15, an analyzing module 16, and an output module 17. In the embodiment, the system 1 cooperates with the Internet 20 and a user terminal 30.

The news-establishing module 11 establishes a plurality of original news data. In this embodiment, the news-establishing module 11 directly searches the Internet 20 to get the required data, and then establishes the original news data 41. The news-establishing module 11, for example, searches electronic papers in the Internet 20, and then creates the original news data 41 according to the contents, figures and tables of the searched electronic papers.

The news database 12 stores the original news data 41. In this embodiment, when the news-establishing module 11 establishes the original news data 41, the original news data 41 is then stored in the news database 12. The stored original news data 41 should include the related data searched from the Internet 20, such as the contents, figures, and tables.

The key-word database 13 stores plural sets of key words 131, and the stored sets of key words 131 at least include a plurality of classification codes. In the present embodiment, the sets of key words 131 are inputted and stored in the key-word database 13 in advance. The key words 131 should include classification code information and, in particular, include international classification code information. The classification codes can be product classification codes, composition classification codes, level classification codes, or the likes. The product classification codes are, for example, agricultural product classification codes, electronic product classification codes, and the likes. The composition classification codes are, for example, the Anatomic-Therapeutic-Chemical (ATC) classification codes. The level classification codes are, for example, the Richter earthquake magnitude level classification codes, the terror threat level classification codes. It should be noted that the classification codes could be generally acknowledged international classification codes. Besides, the classification codes could also be defined by the user.

The value-adding module 14 generates at least one value-added news information 42 according to at least one key word 131 and at least one original news data 41. In the embodiment, the value-adding module 14 establishes at least one relationship table according to at least one of the key words 131 and at least one of the original news data 41. The value-adding module 14 then integrates the relationship table and the original news data 41 to generate the value-added news information 42. Alternatively, the value-adding module 14 may integrate at least one of the key words 131 and at least one of the original news data 41. For example, at least one tag is added into the content of the original news data 41 according to the key word 131. In this case, the tag presents the relation between the tagged portion of the content of the original news data 41 and the key word 131. The value-adding module 14 adds the tag into the original news data 41 so as to generate the desired value-added news information 42. The generated value-added news information 42 is then stored in the news database 12.

The request receiving module 15 receives at least one request 31 from the user terminal 30. The user terminal 30 can transmit the request 31 to the request receiving module 15 via the Internet 20 or any other specific line. Generally, the request 31 contains the news item that the user of the user terminal 30 is interested such as the medicine news, politics news, technology news, economy news, and the likes. In this case, the user terminal 30 can be any electrical product such as a personal digital assistant (PDA), mobile phone, or a computer. It is to be noted that any device, which can be employed as a user interface for outputting the request 31, is a suitable user terminal of the invention.

The analyzing module 16 finds out the value-added news information 42, which matches the request 31. In this embodiment, the analyzing module 16 analyzes the information of the request 31, such as the news item that the user is interested. The analyzing module 16 then searches the news database 12 to find out the value-added news information 42, which matches the request 31. Furthermore, the analyzing module 16 may perform at least one of the content analysis, issue construction, crisis-degree analysis, and case-based reasoning.

Finally, the output module 17 outputs the value-added news information 42 found out by the analyzing module 16. More particularly, the output module 17 outputs the value-added news information 42 to the user terminal 30 according to the request 31 so as to provide the personalized news service. In the current embodiment, when the value-added news information 42 includes the original news data 41 and the relationship table, the output module 17 outputs the original news data 41 and the relationship table to complete the output of the value-added news information 42. Alternatively, when the value-added news information 42 is integrated of the original news data 41 and the key words 131 and, for example, includes the original news data 41 with the tag according to the key word 131, the output module 17 directly outputs the tagged value-added news information 42 to the user terminal 30 so as to complete the output of the value-added news information 42. It should be noted that the output module 17 could output the value-added news information 42 to the user terminal 30 via the Internet 20, the specific line or any other transmission route.

Moreover, when the analyzing module 16 performs the content analysis, issue construction, crisis-degree analysis, and/or case-based reasoning, the output module 17 outputs the result(s) of the content analysis, issue construction, crisis-degree analysis, and/or case-based reasoning to the user terminal 30.

It should be noted that the system for pervading news service 1 might be applied in an electrical apparatus, such as the conventional computer including a central processing unit (CPU), a storage device and an I/O interface. The CPU could be any conventional central processor and, for example, includes an arithmetic logic unit (ALU), a register, and a controller. The CPU processes and calculates vary kinds of data and controls every element of the electrical apparatus. The storage device could be a hard disk, a CD-ROM driver, a dynamic random access memory (DRAM), an electric erase program read only memory (EEPROM), or the likes, which is computer readable data storing device. The I/O interface could be an Ethernet card, which is the interface for inputting data into the electrical apparatus or for outputting data from the electrical apparatus.

As mentioned above, the modules of the embodiment can be software modules stored in the storage device. In such a case, the CPU executes the software modules to drive the elements of the electrical apparatus, such as the storage device and the I/O interface, so that the functions of the above-mentioned modules can be carry out. Those skilled in the art should know that the software modules could be programmed into hardware modules, such as the application-specific integrated circuit (ASIC). Furthermore, the news database or the key-word database can be any database established in the electrical apparatus, such as an electrical database stored in the storage device. Wherein, it is not meant to limit the invention being carried out by hardware, software, firmware or the mixing of the above.

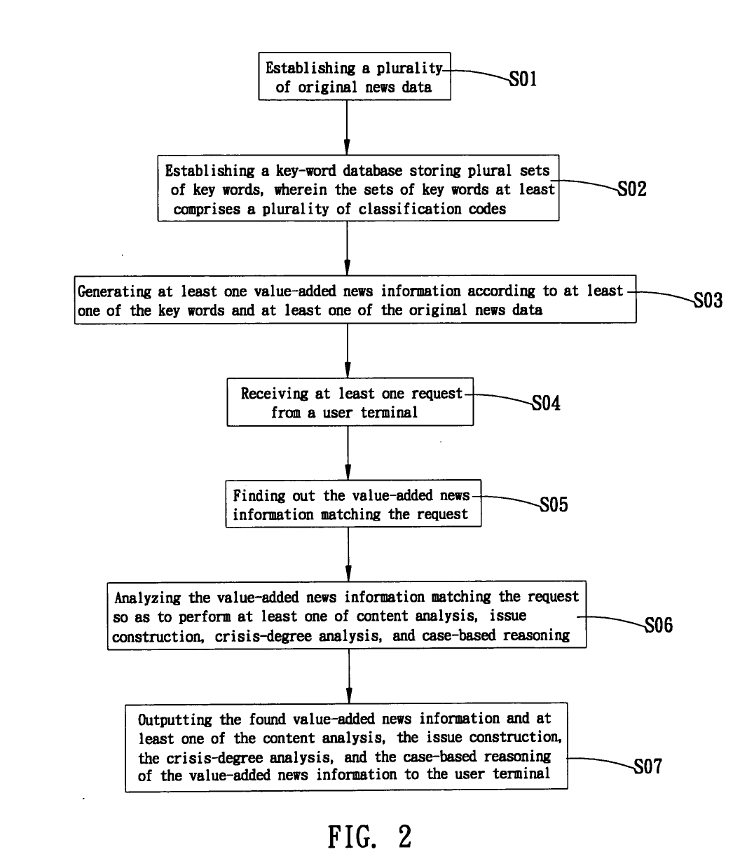

With reference to FIG. 2, the invention further discloses a method for providing news service, which can be performed by the above-mentioned system for providing news service. The method includes the steps of: establishing a plurality of original news data (S01); establishing a key-word database, wherein the key-word database stores plural sets of key words, and the sets of key words at least comprises a plurality of classification codes (S02); generating at least one value-added news information according to at least one of the key words and at least one of the original news data (S03); receiving at least one request from a user terminal (S04); finding out the value-added news information matching the request (S05); analyzing the value-added news information matching the request so as to perform at least one of content analysis, issue construction, crisis-degree analysis, and case-based reasoning (S06); and outputting the found value-added news information and at least one of the content analysis, the issue construction, the crisis-degree analysis, and the case-based reasoning of the value-added news information to the user terminal (S07).

To make the invention more understandable, an example of the method for providing news service according to the preferred embodiment of the invention is described herein after.

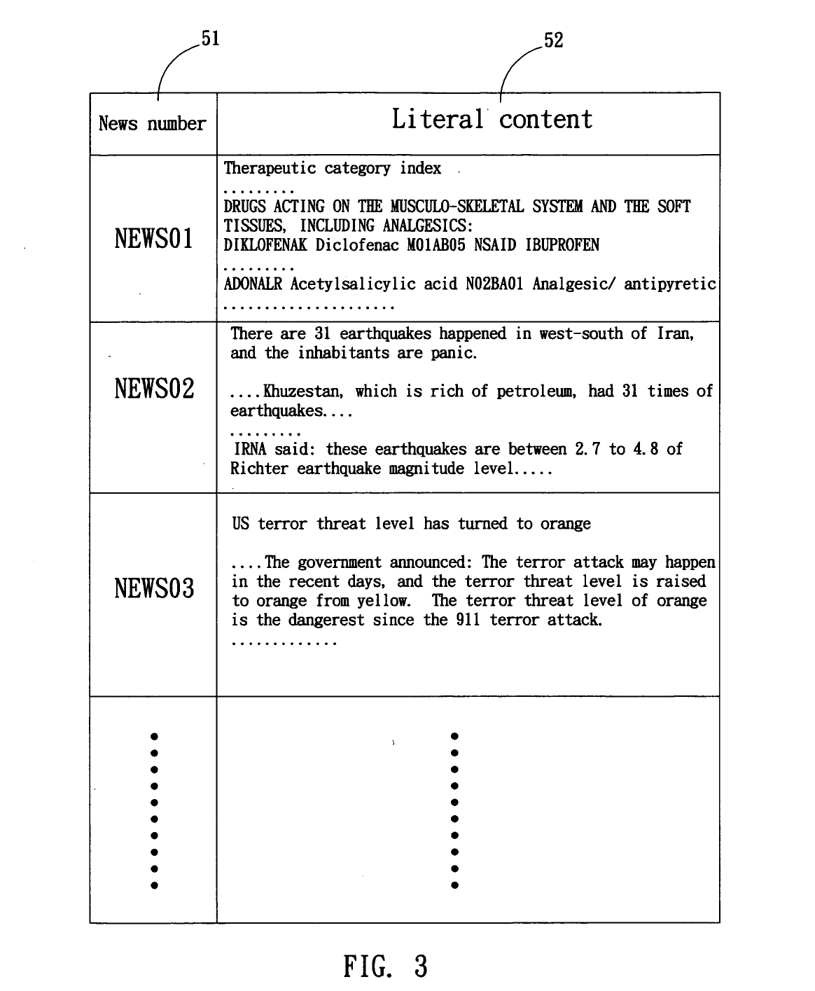

First, the method for providing news service utilizes the news-establishing module to establish a plurality of original news data. In the embodiment, the news-establishing module may directly search the Internet to get the required data, or receive the required data inputted manually. Thus, the original news data can be established. The established original news data is usually stored in a news database as the format shown in FIG. 3. Each original news data includes a news number 51 and a literal content 52. Furthermore, the established original news data may include figures, tables or the likes.

The method of the invention establishes a key-word database, which stores plural sets of key words. The sets of key words at least include a plurality of classification codes. In the current embodiment, the stored key words are usually inputted in advance and include classification code information such as the international classification codes. The classification codes can be product classification codes, composition classification codes, level classification codes, or the likes. For example, the product classification codes are the Anatomic-Therapeutic-Chemical (ATC) classification codes, which are adopted by the WHO to classify the compositions of drugs. For instance, the well-known “Aspirin” is composed of Acetylaslicylic Acid, and has the ATC classification codes of “A01AD05”, “B01AC06”, and “N02BA01”, which present the therapeutic effect thereof. The ATC classification codes of “A01AD05” mean that the drug is used for alimentary tract and metabolism so as to be an agent for local oral treatment. The ATC classification codes of “B01AC06” mean that the drug is used for blood and blood forming organs so as to be a platelet aggregation inhibitor. The ATC classification codes of “N02BA01” mean that the drug is used for nervous system so as to be analgesics and antipyretics. It should be noted that the classification codes could be generally acknowledged international classification codes. Besides, the classification codes could also be defined by the user.

After that, the method utilizes a value-adding module to generate at least one value-added news information according to at least one key word and at least one original news data. In the embodiment, the generated value-added news information is stored in the news database, and the value-adding module, for example, generates the value-added news information by the following ways of:

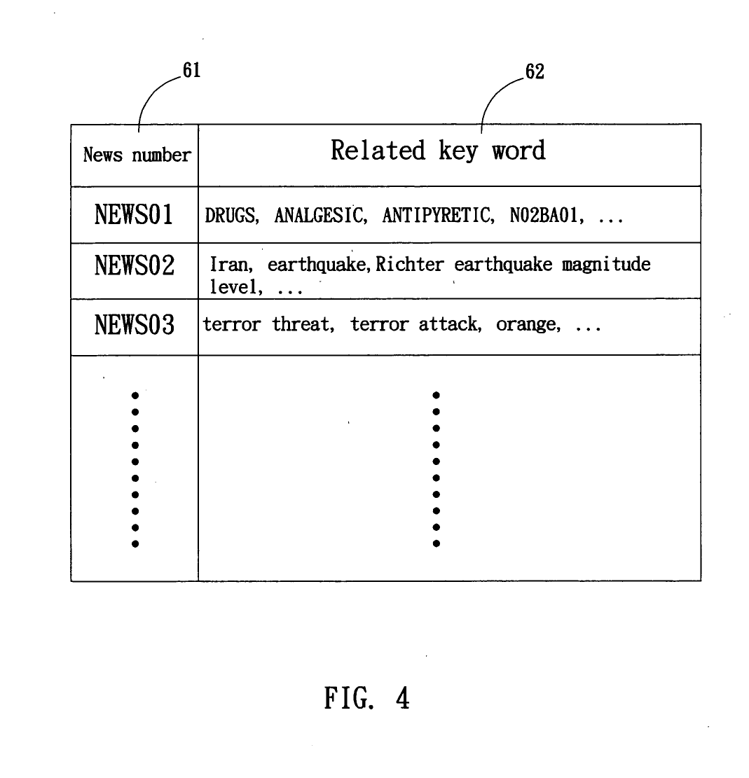

The first way: Establishing at least one relationship table (as shown in FIG. 4) according to at least one of the key words and at least one of the original news data. Integrating the relationship table and the original news data to generate the value-added news information. In this case, the relationship table includes a news number 61 corresponding to the original news data and a related key word 62.

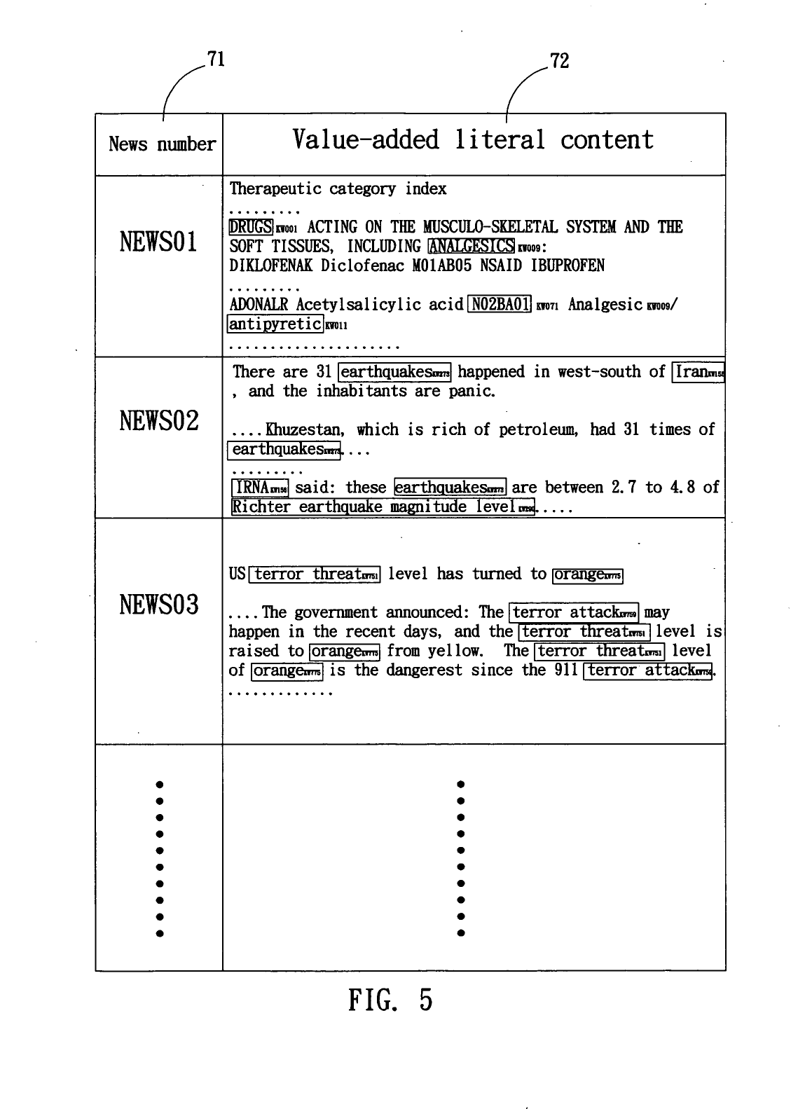

The second way: Integrating at least one of the key words and at least one of the original news data, such as adding at least one tag into the content of the original news data according to the key word. In such a case, the tag presents the relation between the tagged portion of the content of the original news data and the key word. Due to this way of adding the tag, the desired value-added news information (as shown in FIG. 5) is generated and includes a news number 71 and a value-added literal content 72.

The method then utilizes a request receiving module to receive at least one request from a user terminal. In the embodiment, the user terminal can transmit the request to the request receiving module via the Internet or any other specific line. Generally, the request contains the news item that the user of the user terminal is interested such as the medicine news, journal news, patent news, politics news, technology news, economy news, and the likes. For example, the request from the user terminal may contain the medicine news and, in particular, the news of the medicine of analgesics and antipyretics. It should be noted that any of data, articles, contents, information and the likes could be served as the source of the original news data.

As mentioned above, the method of the invention further utilizes an analyzing module to find out the value-added news information matching the request. In this embodiment, the method utilizes the analyzing module to analyze the data of the request, such as the interested news item “the medicine of analgesics and antipyretics”. Then, the analyzing module searches the news database to find out the value-added news information matching the data of the request. For example, the analyzing module may search each value-added news information (as shown in FIGS. 4 and 5), so as to find out the value-added news information having the related key word or the content referring to the tag of “antipyretic”, “analgesic”, “drug”, or “N02BA01”.

Moreover, the method for providing news service may perform at least one of the content analysis, issue construction, crisis-degree analysis, and case-based reasoning.

Finally, the method outputs the found value-added news information through an output module. In the embodiment, the output module may output the original news data and the relationship table to complete the output of the value-added news information. Alternatively, the output module may directly output the tagged value-added news information to the user terminal so as to complete the output of the value-added news information. Moreover, the output module may further output the result(s) of the content analysis, issue construction, crisis-degree analysis, and/or case-based reasoning to the user terminal. Thus, the personalized news service can be provided more efficiency. The value-added news information can be presented to the user by the way of screen displaying, paper report, or voice outputting.

The invention further provides a recording medium, which has a computer readable news service program for providing news service. The news service program includes the following program segments. A news-establishing program segment is for the computer to establish a plurality of original news data. A news database establishing program segment is for the computer to establish a news database, which stores the original news data. A key-word database establishing program segment is for the computer to establish a key-word database, which stores plural sets of key words. The sets of key words at least include a plurality of classification codes. A value-adding program segment is for the computer to generate at least one value-added news information according to at least one of the key words and at least one of the original news data. A request receiving program segment is for the computer to receive at least one request from a user terminal. An analyzing program segment is for the computer to find out the value-added news information matching the request. The value-added news information is outputted to the user terminal according to the request. An output program segment is for the computer to output the value-added news information. In this embodiment, the computer executing the news service program seems as a system for providing news service 1 as shown in FIG. 1.

In summary, the system and method for providing news service of the invention pre-establishes the key-word database, which stores plural sets of classification codes such as the international classification codes. Therefore, the original news data can be classified and/or tagged according to the key words, so as to generate the preferred value-added news information. Moreover, the system and method of the invention can provide the personalized news service fitting the requirements of the clients.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A system for providing news service, comprising:
a news-establishing module, which establishes a plurality of original news data;
a news database, which stores the original news data;
a key-word database, which stores plural sets of key words, the sets of key words at least including a plurality of classification codes;
a value-adding module, which generates at least one value-added news information according to at least one of the key words and at least one of the original news data; and
an output module, which outputs the value-added news information.

2. The system of claim 1, wherein the value-adding module establishes at least one relationship table according to at least one of the key words and at least one of the original news data, and the value-added news information comprises the relationship table and at least one of the original news data.

3. The system of claim 2, wherein the output module outputs the relationship table and at least one of the original news data so as to output the value-added news information.

4. The system of claim 1, wherein the value-adding module integrates at least one of the key words and at least one of the original news data to generate the value-added news information, the value-added news information comprises the content of at least one of the original news data and at least one tag, and the tag is related to at least one of the key words.

5. The system of claim 1, wherein the classification codes are international classification codes.

6. The system of claim 5, wherein the classification codes are Anatomic-Therapeutic-Chemical (ATC) codes.

7. The system of claim 1, wherein the news database further stores the value-added news information.

8. The system of claim 1, which cooperates with at least one user terminal, the system further comprising:
a request receiving module, which receives at least one request from the user terminal; and
an analyzing module, which finds out the value-added news information matching the request, wherein the output module outputs the value-added news information to the user terminal according to the request.

9. The system of claim 8, wherein the user terminal is a personal digital assistant (PDA) or a computer.

10. The system of claim 8, wherein the analyzing module further analyzes the value-added news information matching the request so as to perform at least one of content analysis, issue construction, crisis-degree analysis, and case-based reasoning, and the output module outputs at least one of the content analysis, the issue construction, the crisis-degree analysis, and the case-based reasoning of the value-added news information to the user terminal.

11. A method for providing news service, comprising:
establishing a plurality of original news data;
establishing a key-word database, wherein the key-word database stores plural sets of key words, and the sets of key words at least comprise a plurality of classification codes;
generating at least one value-added news information according to at least one of the key words and at least one of the original news data; and
outputting the value-added news information.

12. The method of claim 11, wherein the step of generating value-added news information comprises:
establishing at least one relationship table according to at least one of the key words and at least one of the original news data, the value-added news information comprising the relationship table and at least one of the original news data.

13. The method of claim 12, wherein the step of outputting the output value-added news information comprises:
outputting the relationship table and at least one of the original news data so as to output the value-added news information.

14. The method of claim 11, wherein the step of generating value-added news information comprises:
integrating at least one of the key words and at least one of the original news data to generate the value-added news information, wherein the value-added news information comprises the content of at least one of the original news data and at least one tag, and the tag is related to at least one of the key words.

15. The method of claim 11, wherein the classification codes are international classification codes.

16. The method of claim 15, wherein the classification codes are Anatomic-Therapeutic-Chemical (ATC) codes.

17. The method of claim 11, which cooperates with at least one user terminal, the method further comprising:
receiving at least one request from the user terminal; and
finding out the value-added news information matching the request so as to output the value-added news information to the user terminal according to the request.

18. The system of claim 17, wherein the user terminal is a personal digital assistant (PDA) or a computer.

19. The method of claim 17, further comprising:
analyzing the value-added news information matching the request so as to perform at least one of content analysis, issue construction, crisis-degree analysis, and case-based reasoning; and
outputting at least one of the content analysis, the issue construction, the crisis-degree analysis, and the case-based reasoning of the value-added news information to the user terminal.

20. The method of claim 11, wherein the original news data and the value-added news information are stored in a news database.

21. A recording medium, which has a computer readable news service program for providing news service, the news service program comprising:
a news-establishing program segment, which is for the computer to establish a plurality of original news data;
a news database establishing program segment, which is for the computer to establish a news database, wherein the news database stores the original news data;
a key-word database establishing program segment, which is for the computer to establish a key-word database, wherein the key-word database stores plural sets of key words, and the sets of key words at least comprise a plurality of classification codes;
a value-adding program segment, which is for the computer to generate at least one value-added news information according to at least one of the key words and at least one of the original news data; and
an output program segment, which is for the computer to output the value-added news information.

22. The recording medium of claim 21, wherein the value-adding program segment is for the computer to establish at least one relationship table according to at least one of the key words and at least one of the original news data, and the value-added news information comprises the relationship table and at least one of the original news data.

23. The recording medium of claim 22, wherein the output program segment is for the computer to output the relationship table and at least one of the original news data so as to output the value-added news information.

24. The recording medium of claim 21, wherein the value-adding program segment is for the computer to integrate at least one of the key words and at least one of the original news data to generate the value-added news information, the value-added news information comprises the content of at least one of the original news data and at least one tag, and the tag is related to at least one of the key words.

25. The recording medium of claim 21, wherein the classification codes are international classification codes.

26. The recording medium of claim 25, wherein the classification codes are Anatomic-Therapeutic-Chemical (ATC) codes.

27. The recording medium of claim 21, wherein the news service program comprising:
a request receiving program segment, which is for the computer to receive at least one request from a user terminal; and
an analyzing program segment, which is for the computer to find out the value-added news information matching the request, wherein the value-added news information is outputted to the user terminal according to the request.

28. The recording medium of claim 27, wherein the user terminal is a personal digital assistant (PDA) or a computer.

29. The recording medium of claim 27, wherein the analyzing program segment is further for the computer to analyze the value-added news information matching the request so as to perform at least one of content analysis, issue construction, crisis-degree analysis, and case-based reasoning, and the output program segment is for the computer to output at least one of the content analysis, the issue construction, the crisis-degree analysis, and the case-based reasoning of the value-added news information to the user terminal.

30. The recording medium of claim 21, wherein the value-added news information is stored in a news database.
